(19) United States
(12) Patent Application Publication
(10) Pub. No.: US 2007/0232734 A1
(43) Pub. Date: Oct. 4, 2007

(54) Polyimide based compositions useful in high frequency circuitry applications and methods relating thereto

(76) Inventors: Karthikeyan Kanakarajan, Dublin, OH (US); Kuppusamy Kanakarajan, Dublin, OH (US); Gary Yonggong Min, Grove City, OH (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/395,735

(22) Filed: Mar. 31, 2006

(51) Int. Cl. C08K 3/22

(52) U.S. Cl. 524/413

(57) ABSTRACT

The invention is directed to polyimide based materials having improved electrical and mechanical performance, and also to a process of making such materials. The compositions of the invention comprise: i. a polyimide base polymer in an amount of at least 60 weight percent; ii. a discontinuous phase of inorganic material present in an amount of at least 4 weight percent; iii. a non-ionic halogenated dispersing agent in an amount of at least 0.1 weight percent; and iv. up to 30 weight percent of other optional ingredients, such as, fillers, processing aids, colorants, or the like. The compositions of the invention generally exhibit excellent high frequency performance and can be manufactured by incorporating the dispersing agent and inorganic material into a polyamic acid solution and then converting the polyamic acid solution into a polyimide by conventional or non-conventional means.

### BACKGROUND OF THE INVENTION

1. Field of the Disclosure

The present invention relates generally to polyimide based compositions useful in electronic type applications, particularly high frequency electronic circuitry applications, such as, planar capacitor substrates, capacitor pastes, and the like. More specifically, the invention is directed to polyimide based materials containing inorganic additives having properties useful in electronic type applications and at least one non-ionic halogenated dispersing agent.

2. Description of Related Art

U.S. Pat. No. 5,078,936 to Parish et al. discloses electrically conductive polyimide articles. The articles are prepared by blending carbon based particles in a polar solvent to form a slurry, then mixing the slurry with a polyamic acid to form a polyimide precursor material. The precursor material is then shaped into a structure and converted into a polyimide based article.

U.S. Pat. No. 6,721,164 to Albertsen et al. discloses dielectric inorganic material incorporated into an organic polymer in combination with a dispersing agent.

### SUMMARY OF THE INVENTION

The present invention is directed to polyimide based materials having improved electrical and mechanical performance, and also to a process of making such materials. The compositions of the present invention comprise: i. a polyimide base polymer in an amount of at least 60, 70, 80, 85, 90 or 95 weight percent; ii. a discontinuous phase of inorganic material among the base polymer, the inorganic material having a capacitive, resistive, conductive or other electronic type property, the inorganic material being present in an amount of at least 4, 5, 10, 15, 20, 25, 30, 35, or 40 weight percent; iii. a non-ionic halogenated dispersing agent in an amount of at least 0.1, 0.2, 0.5, 0.8, 1, 1.2, 1.5, 2.0, 3.0, 4.0, 5.0, 10, or 15 weight percent; and iv. 0, 2, 5, 10, 12, 15, 20, 25 or 30 weight percent other ingredients, such as, fillers, processing aids, colorants, or the like. The compositions of the present invention generally have excellent high frequency performance and also excellent mechanical performance. The compositions of the present invention can be manufactured by incorporating the dispersing agent and inorganic material into a polyamic acid solution and then converting the polyamic acid solution into a polyimide by conventional or non-conventional means.

### DETAILED DESCRIPTION OF THE PREFERRED EMBODIMENT(S)

Barium titanate is a useful inorganic material for capacitor type applications. Other ceramics can also be useful, such as titanium dioxide, silica, and alumina. In one embodiment, the inorganic material is used in the smallest commercially practical particle size achievable. The technical art of dispersing small particles in aqueous and non-aqueous systems is legion and need not be reiterated here. In one embodiment, the average particle size (of the inorganic material) is less than 500, 250, 100, or 50 nanometers.

As the size of a dispersed particle becomes ever smaller, a transition is possible where the material might no longer be considered a particle, but instead, a ‘dissolved solid.’ The inorganic material within the compositions of the present invention will sometimes be referred to as “discontinuous domains” or “discontinuous phase” (rather than as “particles”) as a way to include not only particles, but also, dissolved solids within (or among) the base polymer.

In one embodiment, the ceramic is dispersed (as a discontinuous phase) into a polyamic acid, together with a non-ionic dispersing agent. Polyamic acid is intended to mean a polyimide precursor solution that is ultimately converted into a polyimide by an imidization process. The conversion of polyamic acids into polyimides is well known in the technical art of polyimide chemistry and need not be reiterated here.

The non-ionic, halogenated dispersing agent is used to assist in dispersing the inorganic material into the polyamic acid, and optionally, to assist in breaking down unwanted particle agglomerates. Additionally, mechanical energy (i.e,. mechanical grinding or shearing) or precipitation type processing can also be used to diminish the average domain size of the inorganic material.

The term “non-ionic” used herein to describe the dispersing agent is intended to mean any dispersing agent substantially free of ionic moieties, i.e., less than 1.0, 0.5, 0.2, 0.1, 0.05 or 0.01 moles of moieties have an electric charge, per mole of dispersing agent.

When used in accordance with the present invention, the non-ionic halogenated dispersing agents have been found to provide improved electrical properties in high frequency applications, relative to ionic dispersing agents. While ionic dispersing agents tend to provide excellent dispersing properties when dispersing particulate filler into polyamic acids, it has been discovered that the ionic nature of these dispersing agents can harm or inhibit electrical performance, particularly capacitor performance and most particularly in applications where high frequencies are employed, such as frequencies above one megahertz.

In one embodiment, the dispersion process comprises at least two steps. In a first step, the dispersing agent is fully mixed into a solvent to create a dispersing solution, and thereafter, inorganic filler particles are added. The particles are then dispersed and ideally reduced to their non-agglomerated particle size using mechanical energy, such as, high shear mixing. In such embodiments, a useful dispersing agent is a fluorine-containing surfactant dispersing agent.

The liquid slurry formed therefrom can then be mixed with a polyimide precursor material (e.g., a polyamic acid) to form a polyamic acid casting solution. The casting solution can then be cast alone to form a film cast directly onto a metal foil to form a polyimide composite metal laminate or otherwise formed into any possible shape. Conventional imidization processing, such as the use of thermal energy, can be used to cure the acid into an imide to form a polyimide composite material.

Useful organic solvents for the synthesis of the polyimide composites of the present invention are preferably solvents, or solvent mixtures, capable of dissolving polyimide precursor materials (e.g., varying polyamic acids). Such solvents typically have a relatively low boiling point (e.g., below 225° C.) so that the polyimide can be dried at moderate (more convenient and less costly) temperatures. Typically, solvents having a boiling point of less than 210° C., 205° C., 200° C., 195° C., 190° C., or 180° C. can be useful. Solvents of the present invention may be used alone or in combination with other solvents (i.e., cosolvents). Useful organic solvents include: N-methylpyrrolidone (NMP), dimethyl-pyrrolidin-3-one, dimethylacetamide (DMAc), N,N′-dimethyl-formamide (DMF), dimethyl sulfoxide (DMSO), tetramethyl urea (TMU), hexamethylphosphoramide, dimethylsulfone, tetramethylene sulfone, gamma-butyrolactone, and pyridine. In one embodiment, preferred solvents include N-methylpyrrolidone (NMP) and dimethylacetamide (DMAc).

Co-solvents can also be used generally at about five to 50 weight-percent of the total solvent. Useful co-solvents include xylene, toluene, benzene, diethyleneglycol diethyl ether, 1,2-dimethoxyethane (monoglyme), diethylene glycol dimethyl ether (diglyme), 1,2-bis-(2-methoxyethoxy) ethane (triglyme), bis [2-(2-methoxyethoxy) ethyl)]ether (tetraglyme), bis-(2-methoxyethyl) ether, tetrahydrofuran, propylene glycol methyl ether, propylene glycol methyl ether acetate, “CELLOSOLVE™” (ethylene glycol ethyl ether), butyl “CELLOSOLVE™” (ethylene glycol butyl ether), “CELLOSOLVE™ acetate” (ethylene glycol ethyl ether acetate), and “butyl CELLOSOLVE™ acetate” (ethylene glycol butyl ether acetate).

In the practice of the present invention, a non-ionic fluorine-containing dispersing agent can be added to the organic solvent, or co-solvent mixture (or solvent system) and dissolved to form a dispersing solution. The dispersion solution typically comprises a concentration of non-ionic fluorine-containing dispersing agent between any two of the following numbers, 0.1, 0.5, 1.0, 2.0, 4.0, 5.0, 10.0, 15.0 and 20.0 percent. The dispersing solution is then used to disperse (along with shearing force if necessary) an inorganic filler component, typically inorganic filler particles. While the inorganic filler component can be added directly to the dispersing solution, it is possible to add the inorganic filler component to the organic solvent (co-solvent or solvent system) prior to adding the low-ionic (or non-ionic) fluorine-containing dispersing agent. Generally speaking, the order of addition of these components is not critical to the practice of this invention. Useful non-ionic fluorine-containing dispersing agents employed in the practice of the present invention are described more fully below.

As used herein, the term “non-ionic” fluorine-containing dispersing agent is intended to mean a surfactant comprising molecules having the following structural formula:
R_{f}—CH₂—CH₂—O—(CH₂CH₂O)ₓ—H
where R_{f}=CF₃CF₂(CF₂—CF₂)_{y}; where y is an integer between 1 and 10, and
where x is an integer between 1 and 20. Useful non-ionic (or low ionic) perfluorinated polymers used in the practice of the present invention include, but are not limited to, non-ionic ZONYL® products made by E. I. duPont and Nemours and Co. These non-ionic fluoro-surfactants include a large number of ethoxylated materials, some of which are commercially sold under the trade names ZONYL® FSN-100, ZONYL® FSO, ZONYL® FSO-100, ZONYL® FSH, ZONYL® FS-300 and ZONYL® FS-610.

Generally speaking, fluoro-surfactants can be grouped into four major categories including (I) non-ionic, (ii) anionic, (iii) ionic, and (iv) amphoteric. As a general rule, the non-ionic fluoro-surfactants of the present invention can have a pendant hydrogen group at the end of the polymer chain. Anionic fluoro-surfactants generally have moieties having a negative charge while ionic fluoro-surfactants generally have moieties (at the end of the polymer chain) having a positive charge. Amphoteric fluoro-surfactants can have mixture of positive and negative charge carrying functional groups.

In one embodiment of the present invention, the dispersing agent is a perfluorinated polymer that contains small portions of carboxylate (—COOH) and/or methyl ester (—COOCH₃) functional groups at one end or both ends of the polymer. These polymers can be formed from the polymerization product of the following monomer: 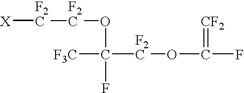
where X can equal a carboxylate (—COOH) group or a methyl ester (—COOCH₃) group. These perfluorinated polymers can be found as solutions sold by E. I. duPont de Nemours and Co. under the trade name NAFION®. While many NAFION® solutions do contain sulfonate groups (—SOOOH3), and are considered to be “ionic”, the present inventor has found that certain NAFION® solutions, classified as non-ionic or low-ionic, can work well in the present invention.

Although dispersing agents having either a positive charge, a negative charge, or both, can perform well as a dispersing agent for many inorganic particle fillers, these dispersing agents tend to form materials having poor electrical performance, particularly at high frequencies. For example, when used as a planar capacitor, compositions comprising ionic dispersing agents tend to exhibit unwanted energy loss (measured in terms of a having a high “dissipation factor”) at operating frequencies of greater than 1 megahertz. Generally, the dissipation factor for compositions of the present invention are less than 0.08, 0.06, 0.05, 0.04, 0.03, 0.02, 0.01, 0.008, 0.005, or 0.001.

The non-ionic halogen-containing surfactants of the present invention have been found to both (I) disperse inorganic fillers well in solvents common to polyimide processing, and (ii) have little (if any) adverse effect on the polymer composite's electrical performance in high frequency applications.

The planar capacitors of the present invention tend to provide a dissipation factor of less than 0.08, 0.075, 0.07, 0.06, 0.05, 0.04, 0.03, 0.02, 0.01 or less than 0.001.

The non-ionic dispersing agent of the present invention can be added either as a solid or as a liquid to an organic solvent (or solvent system, co-solvent, or co-solvent system) to form a dispersing solution. In one embodiment, the dispersing agent is allowed to fully dissolve using any known means of dissolving polymers (and/or chemicals) in an organic solvent. Examples of useful dispersing methods include, but are not limited to, mechanical agitation, heat, and the like. In one embodiment of the present invention, an organic solvent is heated to about 100 to 120 degrees C. and then put under agitation or shear mixing for about 1 to 4 hours.

In another embodiment of the present invention, a non-ionic fluorine containing dispersing agent is added to an organic solvent within a range between any two of the following numbers, 0.01, 0.5, 1.0, 2.0, 3.0, 4.0, 5.0, 10.0 and 20.0 weight percent. The dispersing polymer can be added to the organic solvent prior to or after the inorganic filler is added. Typically, the dispersing polymer is added to the solvent prior to the addition of inorganic filler particles to ensure that the particles are being added to a mixture that can readily disperse the particles without forming unwanted agglomerates. Typically, the amount of inorganic filler particles added to the solvent mixture (typically containing the dispersing polymer already dissolved) can range depending on the final application of the polyimide composite.

In accordance with the present invention, about 10 to 150 weight parts inorganic filler particles can be added to 100 weight parts solvent to create the slurry. The slurry of the organic solvent, the non-ionic dispersing agent, and the inorganic filler can be referred to more generally as an inorganic filler component. The inorganic filler component can have particles dispersed to the level of having an average particle size in a range between (and including) any two of the following sizes: 50, 55, 60, 65, 70, 75, 80, 85, 90, 95, 100, 125, 150, 175, 200, 250, 300, 350, 400, 450, 500 and 5,000 nanometers, where at least 80, 85, 90, 92, 94, 95, 96, 98, 99 or 100 percent of the dispersed filler is within the above size range(s). Generally speaking, ‘filler size’ can be determined by a laser particle analyzer (e.g., HORIBA® laser particle analyzer).

In general, the practice of the present invention allows manufacturers to both extend the limits of how much inorganic filler component can be dispersed into a polymer binder (e.g., a polyimide binder matrix) while maintaining good electrical performance such as ‘low dissipation loss.’ In some cases, when the amount of allowable filler is dramatically increased, a polyimide composite material formed can have greater performance characteristics as a capacitor (i.e., become a capacitor having a higher Dₖ). In one embodiment where the polyimide film composite comprises a barium titanate filler for use as a composite film (typically used as a buried capacitor in a flexible or rigid circuit board), the maximum allowable amount of barium titanate can often be raised from about 60 weight percent to about 80 weight percent, while maintaining the dissipation factor at substantially a constant level.

In one embodiment of the present invention, a polyimide film composite is formed having a thickness ranging from about 2, 5, 10, 15, 20, 25, 30, 35, 40, 50, 60, 70, 80, 90, 100, 150, 200, 250 and 300 microns, or when cast onto a metal foil can have a thickness ranging from about 1, 2, 3, 4, 5, 10, 15, 20, 25, 30, 35, 40, 50, 60, 70, 80, 90, 100, 150, 200, 250 and 300 microns. Filler components of the present invention are selected to provide a polyimide film composite with certain desired physical properties. The properties include electrical conductivity, capacitance, thermal conductivity, color, and the like. While there exists an exhaustive list of possible inorganic filler particles capable of being used in the practice of the present invention, some useful fillers include (but are not limited to) silica, boron nitride, boron nitride coated aluminum oxide, granular alumina, granular silica, fumed silica, silicon carbide, aluminum nitride, aluminum oxide coated aluminum nitride, titanium dioxide, barium titanate, silicon carbide, diamond, dicalcium phosphate, carbon black, graphite, electrically conductive polymers, silver, palladium, gold, platinum, nickel, copper or mixtures or alloys of these materials, paraelectric filler powders like Ta₂O₅, HfO₂, Nb₂O₅, Al₂O₃, steatite and mixtures these, perovskites of the general formula ABO₃, crystalline barium titanate (BT), barium strontium titanate (BST), lead zirconate titanate (PZT), lead lanthanum titanate, lead lanthanum zirconate titanate (PLZT), lead magnesium niobate (PMN), and calcium copper titanate, and mixtures thereof.

Polyimide Binders. Useful high dielectric strength polyimide binders of the present invention are derived from a dianhydride component (or the corresponding diacid-diester, diacid halide ester, or tetra-carboxylic acid derivative of the dianhydride) and a diamine component. The dianhydride component is typically any aromatic, aliphatic, or cycloaliphatic dianhydride. The diamine component is typically any aromatic diamine, aliphatic diamine, or cycloaliphatic diamine.

Useful dianhydrides of the present invention include aromatic dianhydrides. These aromatic dianhydrides include, (but are not limited to),
1. pyromellitic dianhydride (PMDA);
2. 3,3′,4,4′-biphenyl tetracarboxylic dianhydride (BPDA);
3. 3,3′,4,4′-benzophenone tetracarboxylic dianhydride (BTDA);
4. 4,4′-oxydiphthalic anhydride (ODPA);
5. 3,3′,4,4′-diphenylsulfone tetracarboxylic dianhydride (DSDA);
6. 2,2-bis(3,4-dicarboxyphenyl) 1,1,1,3,3,3-hexafluoropropane dianhydride (6FDA);
7. 4,4′-(4,4′-isopropylidenediphenoxy)bis(phthalic anhydride) (BPADA);
8. 2,3,6,7-naphthalene tetracarboxylic dianhydride;
9. 1,2,5,6-naphthalene tetracarboxylic dianhydride;
10. 1,4,5,8-naphthalene tetracarboxylic dianhydride;
11. 2,6-dichloronaphthalene-1,4,5,8-tetracarboxylic dianhydride;
12. 2,7-dichloronaphthalene-1,4,5,8-tetracarboxylic dianhydride;
13. 2,3,3′,4′-biphenyl tetracarboxylic dianhydride;
14. 2,2′,3,3′-biphenyl tetracarboxylic dianhydride;
15. 2,3,3′,4′-benzophenone tetracarboxylic dianhydride;
16. 2,2′,3,3′-benzophenone tetracarboxylic dianhydride;
17. 2,2-bis(3,4-dicarboxyphenyl) propane dianhydride;
18. 1,1-bis(2,3-dicarboxyphenyl) ethane dianhydride;
19. 1,1-bis(3,4-dicarboxyphenyl) ethane dianhydride;
20. bis-(2,3-dicarboxyphenyl) methane dianhydride;
21. bis-(3,4-dicarboxyphenyl) methane dianhydride;
22. 4,4′-(hexafluoroisopropylidene) diphthalic anhydride;
23. bis-(3,4-dicarboxyphenyl) sulfoxide dianhydride;
24. tetrahydrofuran-2,3,4,5-tetracarboxylic dianhydride;
25. pyrazine-2,3,5,6-tetracarboxylic dianhydride;
26. thiophene-2,3,4,5-tetracarboxylic dianhydride;
27. phenanthrene-1,8,9,10-tetracarboxylic dianhydride;
28. perylene-3,4,9,10-tetracarboxylic dianhydride;
29. bis-1,3-isobenzofurandione;
30. bis-(3,4-dicarboxyphenyl) thioether dianhydride;
31. bicyclo[2,2,2]oct-7-ene-2,3,5,6-tetracarboxylicdianhydride;
32. 2-(3′,4′-dicarboxyphenyl) 5,6-dicarboxybenzimidazole dianhydride;
33. 2-(3′,4′-dicarboxyphenyl) 5,6-dicarboxybenzoxazole dianhydride;
34. 2-(3′,4′-dicarboxyphenyl) 5,6-dicarboxybenzothiazole dianhydride;
35. bis-(3,4-dicarboxyphenyl) 2,5-oxadiazole 1,3,4-dianhydride;
36. bis-2,5-(3′,4′-dicarboxydiphenylether) 1,3,4-oxadiazole dianhydride;
37. bis-2,5-(3′,4′-dicarboxydiphenylether) 1,3,4-oxadiazole dianhydride;
38.5-(2,5-dioxotetrahydro)-3-methyl-3-cyclohexene-1,2-dicarboxylic anhydride;
39. trimellitic anhydride 2,2-bis(3′,4′-dicarboxyphenyl)propane dianhydride;
40. 1,2,3,4-cyclobutane dianhydride;
41. 2,3,5-tricarboxycyclopentylacetic acid dianhydride;
42. their acid ester and acid halide ester derivatives;
43. and the like.

Useful aromatic diamines of the present invention include, but are not limited to,
1. 2,2 bis-(4-aminophenyl) propane;
2. 4,4′-diaminodiphenyl methane;
3. 4,4′-diaminodiphenyl sulfide (4,4′-DDS);
4. 3,3′-diaminodiphenyl sulfone (3,3′-DDS);
5. 4,4′-diaminodiphenyl sulfone;
6. 4,4′-diaminodiphenyl ether (4,4′-ODA);
7. 3,4′-diaminodiphenyl ether (3,4′-ODA);
8. 1,3-bis-(4-aminophenoxy) benzene (APB-134 or RODA);
9. 1,3-bis-(3-aminophenoxy) benzene (APB-133);
10. 1,2-bis-(4-aminophenoxy) benzene;
11. 1,2-bis-(3-aminophenoxy) benzene;
12. 1,4-bis-(4-aminophenoxy) benzene;
13. 1,4-bis-(3-aminophenoxy) benzene;
14. 1,5-diaminonaphthalene;
15. 1,8-diaminonaphthalene;
16. 2,2′-bis(trifluoromethyl)benzidine;
17. 4,4′-diaminodiphenyldiethylsilane;
18. 4,4′-diaminodiphenylsilane;
19. 4,4′-diaminodiphenylethylphosphine oxide;
20. 4,4′-diaminodiphenyl-N-methyl amine;
21. 4,4′-diaminodiphenyl-N-phenyl amine;
22. 1,2-diaminobenzene (OPD);
23. 1,3-diaminobenzene (MPD);
24. 1,4-diaminobenzene (PPD);
25. 2,5-dimethyl-1,4-diaminobenzene;
26. 2-(trifluoromethyl)-1,4-phenylenediamine;
27. 5-(trifluoromethyl)-1,3-phenylenediamine;
28. 2,2-Bis[4-(4-aminophenoxy)phenyl]-hexafluoropropane (BDAF);
29. 2,2-bis(3-aminophenyl) 1,1,1,3,3,3-hexafluoropropane;
30. benzidine;
31. 4,4′-diaminobenzophenone;
32. 3,4′-diaminobenzophenone;
33. 3,3′-diaminobenzophenone;
34. m-xylylene diamine;
35. bisaminophenoxyphenylsulfone;
36. 4,4′-isopropylidenedianiline;
37. N,N-bis-(4-aminophenyl) methylamine;
38. N,N-bis-(4-aminophenyl) aniline
39. 3,3′-dimethyl4,4′-diaminobiphenyl;
40. 4-aminophenyl-3-aminobenzoate;
41. 2,4-diaminotoluene;
42. 2,5-diaminotoluene;
43. 2,6-diaminotoluene;
44. 2,4-diamine-5-chlorotoluene;
45. 2,4-diamine-6-chlorotoluene;
46. 4-chloro-1,2-phenylenediamine;
47. 4-chloro-1,3-phenylenediamine;
48. 2,4-bis-(beta-amino-t-butyl) toluene;
49. bis-(p-beta-amino-t-butyl phenyl) ether;
50. p-bis-2-(2-methyl-4-aminopentyl) benzene;
51. 1-(4-aminophenoxy)-3-(3-aminophenoxy) benzene;
52. 1-(4-aminophenoxy)-4-(3-aminophenoxy) benzene;
53. 2,2-bis-[4-(4-aminophenoxy)phenyl] propane (BAPP);
54. bis-[4-(4-aminophenoxy)phenyl] sulfone (BAPS);
55. 2,2-bis[4-(3-aminophenoxy)phenyl] sulfone (m-BAPS);
56. 4,4′-bis-(aminophenoxy)biphenyl (BAPB);
57. bis-(4-[4-aminophenoxy]phenyl) ether (BAPE);
58. 2,2′-bis-(4-aminophenyl)-hexafluoropropane (6F diamine);
59. bis(3-aminophenyl)-3,5-di(trifluoromethyl)phenylphosphine oxide
60. 2,2′-bis-(4-phenoxy aniline) isopropylidene;
61. 2,4,6-trimethyl-1,3-diaminobenzene;
62. 4,4′-diamino-2,2′-trifluoromethyl diphenyloxide;
63. 3,3′-diamino-5,5′-trifluoromethyl diphenyloxide;
64. 4,4′-trifluoromethyl-2,2′-diaminobiphenyl;
65. 4,4′-oxy-bis-[(2-trifluoromethyl) benzene amine];
66. 4,4′-oxy-bis-[(3-trifluoromethyl) benzene amine];
67. 4,4′-thio-bis-[(2-trifluoromethyl) benzene-amine];
68. 4,4′-thiobis-[(3-trifluoromethyl) benzene amine];
69. 4,4′-sulfoxyl-bis-[(2-trifluoromethyl) benzene amine;
70. 4,4′-sulfoxyl-bis-[(3-trifluoromethyl) benzene amine];
71. 4,4′-keto-bis-[(2-trifluoromethyl) benzene amine];
72. 9,9-bis(4-aminophenyl)fluorene;
73. 1,3-diamino-2,4,5,6-tetrafluorobenzene;
74. 3,3′-bis(trifluoromethyl)benzidine;
75. and the like.

Useful aliphatic diamines of the present invention, used alone or in conjunction with either an aromatic diamine, include but are not limited to, 1,6-hexamethylene diamine, 1,7-heptamethylene diamine, 1,8-octamethylenediamine, 1,9-nonamethylenediamine, 1,10-decamethylenediamine (DMD), 1,11-undecamethylenediamine, 1,12-dodecamethylenediamine (DDD), 1,16-hexadecamethylenediamine, 1,3-bis(3-aminopropyl)-tetramethyldisiloxane, isophoronediamine, and combinations thereof.

The dianhydride and diamine components of the present invention are particularly selected to provide the polyimide binder with certain desirable properties. One such property is for the polyimide binder to have a certain glass transition temperature (Tg). One useful Tg range can be between and including any two of the following numbers, 250° C., 240° C., 230° C., 220° C., 210° C., 200° C., 190° C., 180° C., 170° C., 160° C., 150° C., 140° C., 130° C., 120° C., 110° C. and 100° C. if for example good adhesivity of the binder is required. Another useful range, if self-adherability is less important than other properties, is from 550° C., 530° C., 51 0° C., 490° C., 470° C., 450° C., 430° C., 410° C., 390° C., 370° C., 350° C., 330° C., 310° C., 290° C., 270° C., and 250° C. Not all of the dianhydrides and diamines listed above will form either a low-Tg polyimide binder or a high-Tg binder. As such, the selection of which dianhydride, and which diamine components, is needed is an important issue for customizing the final properties of the polymer binder.

In one embodiment of the present invention, p-phenylene diamine is used in combination with 4,4′-ODA as a second diamine. In this embodiment, a combination of BPDA and PMDA is used as the dianhydride component to form the polyimide binder. In another embodiment, PMDA is used with 4,4-ODA to form the polyimide. In this embodiment, a precursor to the polyimide binder component (i.e., a polyamic acid) was homogeneously blended with about 50 weight-percent aluminum oxide filler. The resulting mixed polymer was thermally converted to a 1-mil thick, filled-polyimide film composite. The film composite had a thermal conductivity of about 0.7 watts/(meter*K), and a Tg of greater than 350° C.

In another embodiment of the present invention, useful dianhydrides include BPADA, DSDA, ODPA, BPDA, BTDA, 6FDA, and PMDA or mixtures thereof. These dianhydrides are readily commercially available and generally provide acceptable performance. One noteworthy dianhydride is BPADA because it can produce a polyimide having excellent adhesivity and good flex life while also having a relatively low, moisture absorption coefficient.

In one embodiment of the present invention, a polyimide is synthesized by first forming a polyimide precursor (typically a polyamic acid solution). The polyamic acid is created by reacting (in a solvent system) one or more dianhydride monomers with one or more diamine monomers. In one embodiment, if the filler particles are sufficiently dispersed in the inorganic filler component, a polyamic acid can be added to the inorganic filler component. More commonly, the inorganic filler component is added to a polyamic acid. This is generally true at least until imidization of the polymer (i.e., solvent removal and curing) increases the viscosity of the polymer beyond the point where the inorganic filler component can be adequately dispersed in the binder.

Weight loading of inorganic filler in the polyimide binders of the present invention can generally range between and including any two of the following numbers 40, 45, 50, 55, 60, 65, 70, 75, 80, 85, 90, 95, 100, 105, 110, 120, 130, 140 and 150 weight parts per 100 weight parts polyimide binder. In one embodiment, the inorganic filler component can require extensive milling and filtration to breakup unwanted particle agglomeration. Indeed in one embodiment of the present invention, barium titanate is suspendable at 120 weight-parts per 100 weight parts polyimide.

In one embodiment of the present invention, inorganic filler component is mixed with a polyamic acid to form a mixed polymer blend. The mixed polymer blend is cast onto a flat sheet to form a wet film. Ultimately, the polyimide precursor (i.e., the polyamic acid) is converted into a high-temperature polyimide material having a solids content greater than about 99.5 weight percent (discounting the filler). At some point in this process, the viscosity of the binder is increased beyond the point where the filler material can be blended with polyimide precursor. Depending upon the particular embodiment herein, the viscosity of the binder can possibly be lowered again by solvating the material, perhaps sufficiently enough to allow dispersion of more filler material into the binder.

In another embodiment of the present invention, the mixed polymer blend is cast onto a metal foil. The cast on metal laminate is heated so that the polyamic acid is converted to a polyimide. Here, the polyimide composite is on one side of a metal foil and a polyimide composite metal laminate is formed. In yet another embodiment, these one sided laminates can be bonded together so that the polymer composite is between two metal foils. This type of lamination can occur without using an adhesive, wherein the polyimide binder has enough bonding strength to bond to itself (or where higher Tg polyimides are used) an adhesive layer can be used. A single polyimide metal-clad of the present invention comprises a flexible polyimide composite layer which can adhere to a metal foil such as copper, aluminum, nickel, steel or an alloy containing one or more of these metals. In some cases, the polyimide composite layer can adhere firmly to the metal, having a peel strength of greater than 2 pounds per linear inch and higher, without using an additional adhesive. The metal may be adhered to one or both sides of the polyimide layer. In other cases, an adhesive can be used to laminate the polyimide film composite to a metal layer. Common adhesives are polyimide adhesive, acrylic-based adhesives, and epoxies.

As used herein, the term metal foils do not have to be used as elements in pure form; they may also be used as metal foil alloys, such as copper alloys containing nickel, chromium, iron, and other metals. Other useful metals include, but are not limited to, copper, steel, aluminum, brass, a copper molybdenum alloy, KOVAR®, INVAR®, a bimetal, a trimetal, a tri-metal derived from two-layers of copper and one layer of INVAR®, and a trimetal derived from two layers of copper and one layer of molybdenum.

Polyamic acid solutions can be converted to high temperature polyimides using processes and techniques commonly known in the art such as heat or conventional polyimide conversion chemistry. Such polyimide manufacturing processes have been practiced for decades. The amount of public literature on polyimide manufacture is legion and hence further discussion herein is unnecessary. Any conventional or non-conventional polyimide manufacturing process can be appropriate for use in accordance with the present invention provided that a precursor material is available having a sufficiently low viscosity to allow filler material to be mixed. Likewise, if the polyimide is soluble in its fully imidized state, filler can be dispersed at this stage prior to forming into the final composite.

Other useful methods for producing polyimide films in accordance with the present invention can be found in U.S. Pat. Nos. 5,166,308 and 5,298,331 and are incorporated by reference into this specification for all teachings therein. Numerous variations are also possible, such as:

(a) A method wherein the diamine monomers and dianhydride monomers are preliminarily mixed together and then the mixture is added in portions to a solvent while stirring.

(b) A method wherein a solvent is added to a stirring mixture of diamine and dianhydride monomers (contrary to (a) above).

(c) A method wherein diamines are exclusively dissolved in a solvent and then dianhydrides are added thereto at such a ratio as allowing to control the reaction rate.

(d) A method wherein the dianhydride monomers are exclusively dissolved in a solvent and then amine components are added thereto at such a ratio to allow control of the reaction rate.

(e) A method wherein the diamine monomers and the dianhydride monomers are separately dissolved in solvents and then these solutions are mixed in a reactor.

(f) A method wherein the polyamic acid with excessive amine component and another polyamic acid with excessive anhydride component are preliminarily formed and then reacted with each other in a reactor, particularly in such a way as to create a non-random or block copolymer.

(g) A method wherein a specific portion of the amine components and dianhydride components are first reacted and then residual dianhydride monomer is reacted, or vice versa.

(h) A method wherein the filler particles are dispersed in a solvent and then injected into a stream of polyamic acid to form a filled polyamic acid casting solution and then cast to form a green film. This can be done with a high molecular weight polyamic acid or with a low molecular weight polyamic acid which is subsequently chain extended to a high molecular weight polyamic acid.

(i) A method wherein the components are added in part or in whole in any order to either part or whole of the solvent, also where part or all of any component can be added as a solution in part or all of the solvent.

(j) A method of first reacting one of the dianhydride monomers with one of the diamine monomers giving a first polyamic acid, then reacting the other dianhydride monomer with the other amine component to give a second polyamic acid, and then combining the amic acids in any one of a number of ways prior to film formation.

In one embodiment of the present invention, a heating system having a plurality of heating sections or zones is used. The maximum heating temperature can be controlled to give a maximum air (or nitrogen) temperature of the ovens from about 200 to 600° C., more preferably from 350 to 500° C. By regulating the maximum curing temperature of the green film within the range as defined above, it is possible to obtain a polyimide film that has excellent mechanical strength and good thermal dimensional stability.

Alternatively, heating temperatures can be set to 200-600° C. while varying the heating time. Regarding the curing time, it is preferable that the polyimide film composites (or metal foil laminates) of the present invention be exposed to the maximum heating temperature for about 1, 2, 3, 5, 10, 15, 20, 25, 30, 35, 40, 45 or 50 seconds to about 60, 70, 80, 90, 100, 200, 400, 500, 700, 800, 900, 1000, 1100 or 1200 seconds (the length of time depending on heating temperature). The heating temperature may be changed stepwise so as not to wrinkle the film by drying to quickly.

The thickness of a polyimide composite may be adjusted depending on the intended purpose of the film or laminate. Depending upon the design criteria of any particular embodiment chosen, the polyimide composite thickness can range between (and including) any two of the following film thicknesses: 5, 8, 10, 15, 20, 25, 30, 35, 40, 45, 50, 60, 80, 100, 125, 150, 175, 200, 300, 400 and 500 microns. In one embodiment, the thickness is from about 12 to about 125 microns and is preferably from 15 to 25 microns.

In another embodiment, the polyimide film composites can be a discrete layer in a multi-polyimide layer film construction. For instance, the polyimide film composite layer can be co-extruded as one layer in a two-layer polyimide, or as the inner (or outer) layers in a three-layer polyimide (see also U.S. Pat. No. 5,298,331, herein incorporated by reference).

In another embodiment, the polyimides of the present invention can be used as a material used to construct a planar transformer component. These planar transformer components are commonly used in power supply devices. In yet another embodiment, the polyimide adhesives of the present invention may be used with thick metal foils (like Inconel) to form flexible heaters. These heaters are typically used in automotive and aerospace applications.

Generally, the polyimide film composites of the present invention are useful as a single-layer base substrate (a dielectric) in an electronic device requiring good dielectric strength. Examples of such electronic devices include (but are not limited) planar capacitors, thermoelectric modules, thermoelectric coolers, DC/AC and AC/DC inverters, DC/DC and AC/AC converters, power amplifiers, voltage regulators, igniters, light emitting diodes, IC packages, and the like.

The advantageous properties of this invention can be observed by reference to the following examples that illustrate, but do not limit, the invention. All parts and percentages are by weight unless other wise indicated.

The advantageous properties of this invention can be observed by reference to the following examples that illustrate, but do not limit, the invention. All parts and percentages are by weight unless other wise indicated.

### EXAMPLE 1

Barium titanate inorganic filler (i.e., known commercially as TICON® CN), ZONYL® FSO-100 dispersing agent and DMAc solvent were added to a 500ml ceramic jar containing 250g ceramic balls (0.65 mm YTZ media, i.e., ZrO₂ based ceramic ball). The ceramic jar was placed onto a roll mill for over night at a rotation speed of about 20 rpm. Next, 19 weight percent PMDA//4,4-ODA polyamic acid was added to the jar and kept stirring for 10 minutes. A 25-micron thick film (having 80 weight percent barium titanate filler and 2.0 weight percent dispersing agent on a polymer weight basis) was cast on a glass plate and heated to a temperature of about 80 to 100 degree C. The film was then peeled from the plate and thermally ‘imidized’ at 150° C. for 10 minutes and 350° C. for another 10 minutes.

The cured polyimide composite was evaluated as having:

Dielectric Constant (Dk)
31 @ 1 KHz
30 @ 1 MHz
Dissipation Factor (D_{f}),
0.014 @1 KHz
0.072 @ 1 MHz
Capacitance
4200 pf @ 1 KHz
4018 pf @ 1 MHz

### COMPARATIVE EXAMPLE 1

The following comparative example was prepared in accordance with Example 1. In contrast (an in place of using ZONYL® FSO-100® as the dispersing agent) NAFION® sulfonate was used as the dispersing agent, i.e., an ionic dispersing agent. While most of the electrical properties above remained the same, the dissipation factor (D_{f}) was measured at 0.1097.

We claim:

1. A process for preparing a capacitive polyimide based composition comprising:
(a) combining a non-ionic halogenated dispersing agent in an organic solvent to form a dispersing solution,
(b) incorporating a plurality of inorganic capacitive domains into the dispersing solution to form an inorganic filler component,
(c) combining the inorganic filler component with a polyamic acid solution to form a mixed polymer solution,
(d) converting the mixed polymer solution to form a polyimide based composition comprising at least 60 weight percent polyimide base polymer, at least 4 weight percent inorganic domains, and at least 0.1 percent non-ionic halogenated dispersing agent, wherein the amount of dispersing agent is sufficient to provide a dissipation factor for the polyimide based composition of less than 0.08 at 1 megahertz.

2. A process in accordance with claim 1, wherein prior to or during imidizing, the mixed polymer solution is formed into a film, and the film is stretched during imidizing, and wherein the dispersing agent contains a fluorine moiety.

3. A process in accordance with claim 2, wherein the dispersing agent is a perfluorinated polymer derived from a monomer represented by the following structural formula, 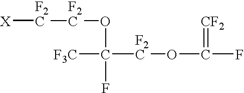
where X is a non-ionic group.

4. A process in accordance with claim 1, wherein the dispersing agent is represented by the following structural formula:
R_{f}—CH₂—CH₂—O—(CH₂CH₂O)ₓ—H
wherein R_{f}=CF₃CF₂(CF₂—CF₂)_{y};
wherein y is an integer between 1 and 10, and
wherein x is an integer between 1 and 20.

5. A process in accordance with claim 2, wherein the film is placed between two layers of a metal to provide one or more capacitors.

6. A process in accordance with claim 3, wherein the inorganic domains comprise a composition selected from a group consisting of silica, boron nitride, boron nitride aluminum oxide, silicon carbide, aluminum nitride, titanium dioxide, barium titanate, diamond, dicalcium phosphate, carbon black, graphite, electrically conductive polymer, silver, palladium, gold, platinum, nickel, copper, paraelectric filler powder, steatite, perovskites of the general formula ABO₃, crystalline barium titanate (BT), barium strontium titanate (BST), lead zirconate titanate (PZT), lead lanthanum titanate, lead lanthanum zirconate titanate (PLZT), lead magnesium niobate (PMN), and calcium copper titanate, and mixtures thereof.

7. A process in accordance with claim 2, wherein the polyamic acid comprises a diamine component selected from a group consisting of 2,2 bis-(4-aminophenyl) propane; 4,4′-diaminodiphenyl ethane; 4,4′-diaminodiphenyl sulfide (4,4′-DDS); 3,3′-diaminodiphenyl sulfone (3,3′-DDS); 4,4′-diaminodiphenyl sulfone; 4,4′-diaminodiphenyl ether (4,4′-ODA); 3,4′-diaminodiphenyl ether (3,4′-ODA); 1,3-bis-(4-aminophenoxy) benzene (APB-134 or RODA); 1,3-bis-(3-aminophenoxy) benzene (APB-133); 1,2-bis-(4-aminophenoxy) benzene; 1,2-bis-(3-aminophenoxy) benzene; 1,4-bis-(4-aminophenoxy) benzene; 1,4-bis-(3-aminophenoxy) benzene; 1,2-diaminobenzene (OPD); 1,3-diaminobenzene (MPD); 1,4-diaminobenzene (PPD); 2,5-dimethyl-1,4-diaminobenzene; 2-(trifluoromethyl)-1,4-phenylenediamine; 5-(trifluoromethyl)-1,3-phenylenediamine; 2,2-bis[4-(4-aminophenoxy)phenyl]-hexafluoropropane (BDAF); 2,2′-bis(trifluoromethyl)benzidine; 2,2-bis(3-aminophenyl) 1,1,1,3,3,3-hexafluoropropane; benzidine; 4,4′-diaminobenzophenone; 3,4′-diaminobenzophenone; 3,3′-diaminobenzophenone; 1-(4-aminophenoxy)-3-(3-aminophenoxy) benzene; 1-(4-aminophenoxy)-4-(3-aminophenoxy) benzene; 2,2-bis-[4-(4-aminophenoxy)phenyl] propane (BAPP); bis(3-aminophenyl)-3,5-di(trifluoromethyl)phenylphosphine oxide (BDAF); bis-[4-(4-aminophenoxy)phenyl] sulfone (BAPS); 2,2-bis[4-(3-aminophenoxy)phenyl] sulfone (m-BAPS); 4,4′-bis-(aminophenoxy)biphenyl (BAPB); bis-(4-[4-aminophenoxy]phenyl) ether (BAPE); 2,2′-bis-(4-aminophenyl)-hexafluoropropane (6F diamine); and combinations thereof.

8. A process in accordance with claim 6, wherein the polyamic acid comprises a dianhydride component selected from a group consisting of pyromellitic dianhydride (PMDA); 3,3′,4,4′-biphenyl tetracarboxylic dianhydride (BPDA); 3,3′,4,4′-benzophenone tetracarboxylic dianhydride (BTDA); 4,4′-oxydiphthalic anhydride (ODPA); 3,3′,4,4′-diphenylsulfone tetracarboxylic dianhydride (DSDA); 2,2-bis(3,4-dicarboxyphenyl) 1,1,1,3,3,3-hexafluoropropane dianhydride (6FDA); 4,4′-(4,4′-isopropylidenediphenoxy)bis(phthalic anhydride) (BPADA); 2,3,6,7-naphthalene tetracarboxylic dianhydride; 1,2,5,6-naphthalene tetracarboxylic dianhydride; 1,4,5,8-naphthalene tetracarboxylic dianhydride; 2,6-dichloronaphthalene-1,4,5,8-tetracarboxylic dianhydride; 2,7-dichloronaphthalene-1,4,5,8-tetracarboxylic dianhydride; 2,3,3′,4′-biphenyl tetracarboxylic dianhydride; 2,2′,3,3′-biphenyl tetracarboxylic dianhydride; 2,3,3′,4′-benzophenone tetracarboxylic dianhydride; 2,2′,3,3′-benzophenone tetracarboxylic dianhydride; 2,2-bis(3,4-dicarboxyphenyl) propane dianhydride; 1,1-bis(2,3-dicarboxyphenyl) ethane dianhydride; 1,1-bis(3,4-dicarboxyphenyl) ethane dianhydride; bis-(2,3-dicarboxyphenyl) methane dianhydride; bis-(3,4-dicarboxyphenyl) methane dianhydride; 4,4′-(hexafluoroisopropylidene) diphthalic anhydride; bis-(3,4-dicarboxyphenyl) sulfoxide dianhydride; tetrahydrofuran-2,3,4,5-tetracarboxylic dianhydride; pyrazine-2,3,5,6-tetracarboxylic dianhydride; thiophene-2,3,4,5-tetracarboxylic dianhydride; phenanthrene-1,8,9,10-tetracarboxylic dianhydride; perylene-3,4,9,10-tetracarboxylic dianhydride; bis-1,3-isobenzofurandione; bis-(3,4-dicarboxyphenyl) thioether dianhydride; bicyclo[2,2,2]oct-7-ene-2,3,5,6-tetracarboxylicdianhydride; 2-(3′,4′-dicarboxyphenyl) 5,6-dicarboxybenzimidazole dianhydride; 2-(3′,4′-dicarboxyphenyl) 5,6-dicarboxybenzoxazole dianhydride; 2-(3′,4′-dicarboxyphenyl) 5,6-dicarboxybenzothiazole dianhydride; bis-(3,4-dicarboxyphenyl) 2,5-oxadiazole 1,3,4-dianhydride; bis-2,5-(3′,4′-dicarboxydiphenylether) 1,3,4-oxadiazole dianhydride; 5-(2,5-dioxotetrahydro)-3-methyl-3-cyclohexene-1,2-dicarboxylic anhydride; trimellitic anhydride 2,2-bis(3′,4′-dicarboxyphenyl)propane dianhydride; 1,2,3,4-cyclobutane dianhydride; 2,3,5-tricarboxycyclopentylacetic acid dianhydride; their acid ester and acid halide ester derivatives, and combinations thereof.

9. A process in accordance with claim 7, further comprising a placement of an adhesive layer upon the film, the adhesive layer comprising an acrylic, an epoxy or a thermoplastic polyimide.
